(19) United States
(12) Patent Application Publication
(10) Pub. No.: US 2006/0224452 A1
(43) Pub. Date: Oct. 5, 2006

(54) System and method for incentive-based advertising and marketing

(76) Inventor: Gene F. Ng, Randolph, MA (US)

Correspondence Address: AKC PATENTS, 215 GROVE ST., NEWTON, MA, 02466, US

(21) Appl. No.: 11/390,325

(22) Filed: Mar. 27, 2006

Related U.S. Application Data
(60) Provisional application No. 60/666,130, filed on Mar. 29, 2005.

(51) Int. Cl. G06Q 30/00

(52) U.S. Cl. 705/14

(57) ABSTRACT

A computer implemented method for improving consumers' attention and effectiveness of advertisement. The method includes viewing and/or listening to a specific advertisement, and then connecting to a network based system that includes a database listing of advertisements and selecting the specific advertisement. Next, answering one or more questions about the content of the specific advertisement and receiving reward points for providing correct answers to questions. The specific advertisement includes a mark identifying it and pointing to the network based system.

### CROSS REFERENCE TO RELATED CO-PENDING APPLICATIONS

This application claims the benefit of U.S. provisional application Ser. No. 60/666,130 filed on Mar. 29, 2005 and entitled SYSTEM AND METHOD FOR INCENTIVE-BASED ADVERTISING AND MARKETING which is commonly assigned and the contents of which are expressly incorporated herein by reference.

### FIELD OF THE INVENTION

The present invention relates to a system and a method for incentive-based advertising and marketing.

### BACKGROUND OF THE INVENTION

Mass-media advertising is currently fraught with several problems, including among others the following:
a) The advent of time-shifting video machinery such as TiVo allows viewers to skip past the commercials that pay for the programming;
b) The shotgun approach of mass media advertising wastes advertising dollars to reach people who just have no interest in the product being sold;
c) Consumers do not find the advertisements engaging and most often simply ignore the advertisements;
d) Even if the viewer is interested in purchasing the product, there is a disconnect in that the advertisement does not tell the viewer where she can buy the product, and does not provide coupons with which the consumer can try out the product more cheaply;
e) There is a limited number of time slots in which to air radio and television commercials;
f) Advertisements have to spend much of their time simply trying to get the viewer's attention, leaving little time to mention the company name or the product brand. Advertisers resort to various tricks to get the viewers' attention.

At the point of purchase, i.e., the supermarket or the mall, the infrastructure for rewarding loyal consumers is lacking. Currently, some stores have individual store cards which provide savings for consumers who sign up for the card. The data gathered for each purchase is available to the individual store, but is not made available to the consumer. The consumer has no tool to analyze her purchases or to plan her purchases with automated shopping lists. Also, records are kept for one store only, so that the manufacturer of a product is not able to reward the loyal customer for brand loyalty regardless of which store the consumer shops from.

Accordingly, there is a need for improved advertising and marketing methods and systems.

### SUMMARY OF THE INVENTION

The present invention is directed towards a system and a method for motivating the consumer to make purchases which are encouraged by advertisers, manufacturers and merchants.

In general, in one aspect, the invention features a computer implemented method for improving consumers' attention and effectiveness of advertisement. The method includes the steps of first viewing and/or listening to an advertisement, then connecting to a network based system and selecting the advertisement, then answering one or more questions about the content of the advertisement within the network based system, and then receiving reward points for providing correct answers to the one or more questions. The advertisement includes a mark identifying the advertisement and pointing to the network based system, and the network based system includes a database listing of the advertisement.

Implementations of this aspect of the invention may include one or more of the following features. The network based system may be a website, a telephone station or an interactive television station and it is accessed via a network connection such as the Internet, telecommunications network, local area network (LAN), wide area network (WAN), wireless network, or wired network. The method may further include providing hints assisting the consumers with the answering of the one or more questions. In case where the advertisement includes an advertisement for a product or a service the method further includes providing a link to venues selling the product or service. The method further includes receiving coupons or other incentives for buying the product or service. The method further includes receiving rewards for trying the product or service. The method further includes storing the reward points in a universal incentive card. The universal incentive card includes a unique identification code linking the universal incentive card to a consumer and to a consumer account in the system. The method further includes redeeming the reward points by purchasing goods or services. The network based system further includes a consumer database comprising consumer accounts, and the consumer accounts include information such as consumer user id, consumer security id, consumer profile, purchases, reward points, incentives, coupons, “soft” coupons, interests, or advertisement viewing/listening records. The method further includes recording the reward points into the consumer accounts. The method further includes analyzing the consumer account information, identifying specific consumer group profiles and targeting the specific consumer groups based on their interests and consuming habits. The consumers monitor their consuming habits through the network based system. The method further includes inviting the consumers to view and/or listen to the advertisement. The method further includes registering a consumer into the network based system, and assigning a user id and a security id to the consumer. The method further includes collecting information about the consumer and defining a user profile for the consumer. The network based system includes a website and the website includes a plurality of interlinked web pages stored in a memory and the memory is couple to a computing circuit and to a communications interface for communicating via the Internet. The website provides access to the database listing of the advertisement, ability to select the advertisement based on the mark, ability to view the advertisement, access to consumer accounts, ability to monitor consuming habits, links to stores for buying goods and services, or ability to keep track of reward points. The method further includes entering a user into a prize-winning drawing.

In general, in another aspect, the invention features a system for improving consumers' attention and effectiveness of advertisement including equipment for viewing and/or listening to an advertisement, equipment and applications for connecting to a network based system and selecting the advertisement, means for answering one or more questions about the content of the advertisement within the network based system, and means for receiving reward points for providing correct answers to the one or more questions. The advertisement includes a mark identifying the advertisement and pointing to the network based system, and the network based system includes a database listing of the advertisement.

Among the advantages of this invention may be one or more of the following. The present method encourages consumers to view and remember advertisements by having them answer questions about advertisements and rewarding them with reward points. The reward points can be redeemed by purchasing any type of goods or services. The system further is linked to venues that sell the advertised goods and services and the consumer is encouraged to try and purchase these goods and services and to redeem the reward points directly. The reward points are stored in a universal incentive card that can be used in any store. The advertising viewing habits of consumers are recorded and analyzed and the results are used to address the specific needs of the consumers. This method allows advertisers to target advertising towards specific consumers by compiling profiles of their interests and shopping habits, thereby increasing the return on each advertising dollar spent. It allows advertiser to focus on providing a message rather than painting an image. It solves the disconnect between an advertisement viewer deciding to buy a product and the actual act of buying the product by providing a link to stores that carry the product in the advertisement viewer's locale and by providing coupons and other incentives for the advertisement viewer to follow through with a purchase. It rewards the consumer with more incentives for trying out the advertised product. It provides a computer based tool for consumers to track and analyze their spending and to make shopping lists for different stores by selecting from past purchases, or from an electronic list of goods and services offered.

### BRIEF DESCRIPTION OF THE DRAWINGS

FIG. 1 is a flow diagram of the process for responding to a watermark advertisement;

FIG. 2 depicts the step of FIG. 1 where the advertisement viewer sees a watermark on a TV commercial;

FIG. 3 depicts the step of FIG. 1 where the advertisement viewer sees a watermark on a print advertisement;

FIG. 4 depicts the step of FIG. 1 where the advertisement viewer hears a soundmark on a radio commercial;

FIG. 5 is a flow diagram of the process where the advertisement viewer responds to an advertisement via the web;

FIG. 6 is a flow diagram of the process where the advertisement viewer responds to an advertisement via telephone;

FIG. 7 is a flow diagram of the process where the advertisement viewer responds to an advertisement via interactive TV;

FIG. 8 is a flow diagram for links and promotions;

FIG. 9 is a flow diagram for answering questions;

FIG. 10 is a flow diagram for an invitational advertisement;

FIG. 11 is a flow diagram for signing up for a card;

FIG. 11A is a schematic drawing of a PerqCard;

FIG. 12 is a flow diagram for filling out a questionnaire;

FIG. 13 is a flow diagram for a multi-store universal incentive card marketing database;

FIG. 14 is a flow diagram for redeeming coupons or PerqBucks;

FIG. 15 is a screenshot of the Adperqs welcome screen;

FIG. 16 is a screenshot of the Adperqs watermark advertisements screen;

FIG. 17 is a screenshot of the Adperqs invitational advertisements screen;

FIG. 18 is a screenshot of the Adperqs shopping suggestions screen;

FIG. 19 is a screenshot of the Adperqs shopping list screen;

FIG. 20 is a screenshot of the Adperqs reward summary screen;

FIG. 21 is a screenshot of the Adperqs shop our stores screen;

FIG. 22 is a screenshot of the Adperqs specials-fliers screen;

FIG. 23 is a screenshot of the Adperqs shopping history screen; and

FIG. 24 is a screenshot of the Adperqs template screen.

### DETAILED DESCRIPTION OF THE INVENTION

Definitions

| | |
|---|---|
| Adperqs | The name (for example) of an |
| | entity which uses the present |
| | invention's method of incentive |
| | advertising. |
| Adperqs.com | The website URL of Adperqs |
| 1-800-adperqs | The toll-free telephone number |
| | of the automated, voice |
| | recognition answering line |
| | of the Adperqs entity. This |
| | telephone number is used as |
| | an example only and might |
| | already be taken by another |
| | entity. A real entity employing |
| | this method of incentive |
| | advertising will use a different |
| | telephone number. |
| PerqBucks | A cash equivalent unit of |
| | value used to reward consumers |
| | for purchasing and advertisement |
| | viewing behavior. PerqBucks can |
| | be redeemed at participating |
| | merchants |
| PerqCard | A universal incentive card |
| | that can be used at many |
| | different stores. The PerqCard |
| | stores an identity vault ID |
| | that links to an Adperqs account |
| Identity Vault | The name of the entity which |
| | stores a database which |
| | contains a consumer's real |
| | identification information and |
| | generates an identity vault ID |
| | which secures the identity. |
| | Subsequently, all transactions |
| | are conducted with the |
| | identity vault ID, which keeps |
| | the user's identity private |
| Identity Vault ID | The identification number |
| | associated with a real person, |
| | which is used to conduct |
| | transactions, keeping the identity |
| | of the person secure |
| Idvault.com | The website URL of Identity Vault |
| 1-800-idvault | The toll-free telephone number |
| | of the automated, voice |
| | recognition answering line |
| | of the Identity Vault entity. |
| | This telephone number is |
| | used as an example only and |
| | might already be taken by |
| | another entity. |
| Toyosan | A fictitious name of a car |
| | manufacturer |
| Vanacar | A fictitious name of a brand |
| | of minivans |
| Invitational | Advertisements which consumers |
| Advertisements | are invited to see by a |
| | manufacturer or a merchant |
| Watermark | Advertisements which bear |
| Advertisements | the Adperqs.com watermark, |
| | indicating that the present |
| | advertisement qualifies for |
| | incentives which can be |
| | redeemed at adperqs.com or 1- |
| | 800-adperqs |
| Interactive TV | The medium which will be |
| | available in the future which |
| | allows viewers to interact |
| | with a live television program. |

The present invention describes a method for getting advertisement viewers to pay more attention to commercials and print advertisements. The approach taken is very straight forward. Advertisement viewers are given cash, or cash-equivalent dollars called PerqBucks which can be redeemed for goods and services at participating merchants. To qualify for these PerqBucks, the viewer simply watches a commercial and answers a few simple or complex questions about that commercial.

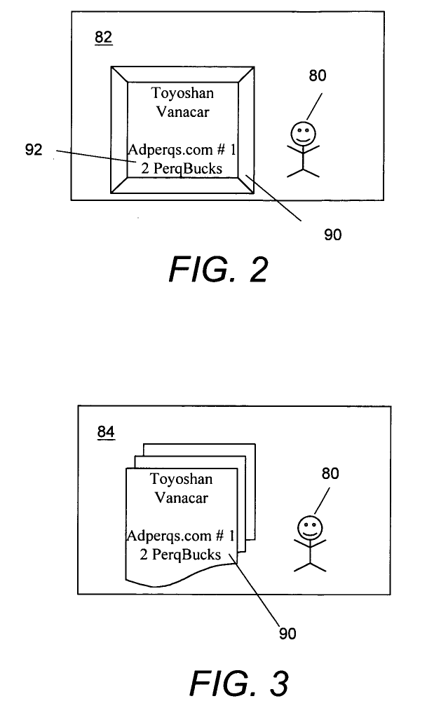

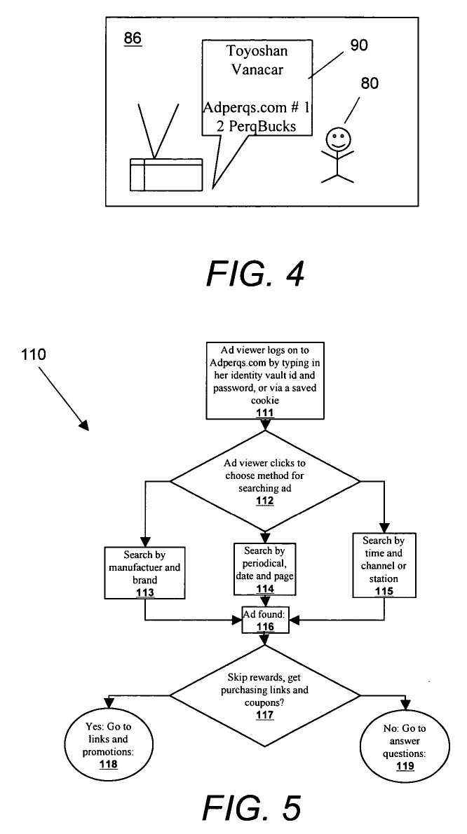

There are two main types of commercials: Watermark advertisements, and Invitational advertisements. Watermark advertisements are television/radio commercials or print advertisements that carry the Adperqs.com watermark. This signifies to viewers that the advertisement has associated rewards which can be redeemed if the viewer pays attention to the advertisement. The watermark consists of the adperqs.com logo along with other identifying information which may include the numeric id of the advertisement and/or the amount of the incentive PerqBucks for watching the advertisement, as shown in FIGS. 2, 3, and 4. Watermark advertisements are available to the general audience to claim rewards. This is in contrast to an “invitational advertisement” which only certain viewers are chosen to see based on their profiles.

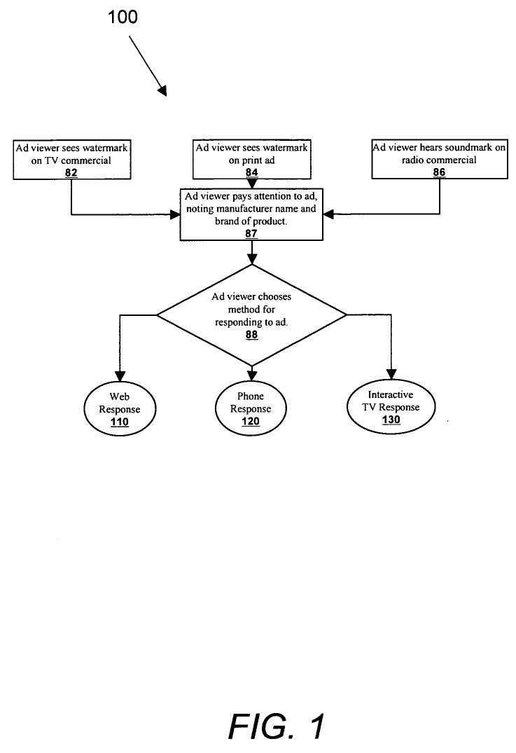

Referring to FIG. 1 the process 100 for responding to a watermark advertisement includes the following. The viewer 80 first sees a watermark advertisement 90 with the adperqs.com logo 92 either while she is watching television 82, shown in FIG. 2, or while she is reading a newspaper or magazine 84, shown in FIG. 3, or while she is listening to the radio 86, shown in FIG. 3. When she sees and/or hears the watermark or soundmark, she will pay special attention to the advertisement because she wants to qualify for the PerqBucks associated with that commercial or advertisement (87). She will pay special attention to the name of the manufacturer and the brand name so that she can easily find the advertisement on the web, or on the phone.

Next the viewer decides on a method to respond to the advertisement (88). She can decide to respond by logging onto the adperqs.com website (110). She can decide to call 1-800-adperqs (120). She can choose to respond by using interactive TV (130). Or she might choose any other means of response offered by Adperqs.

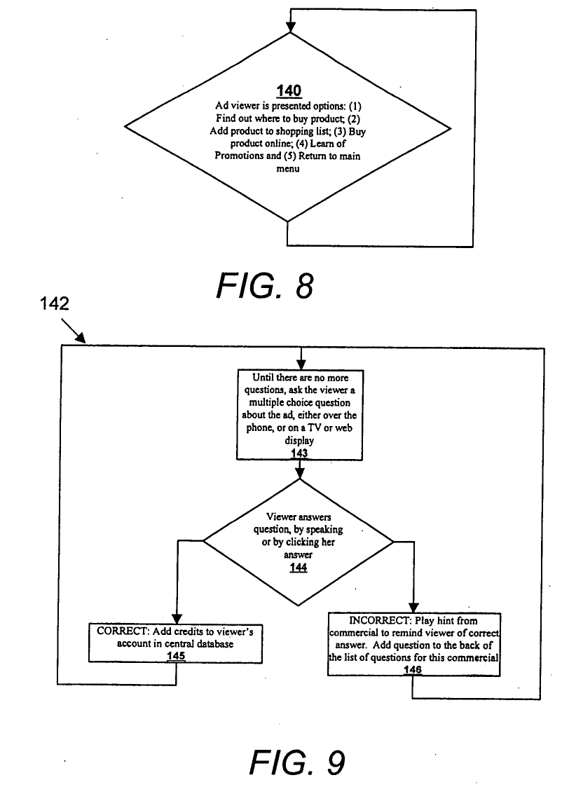

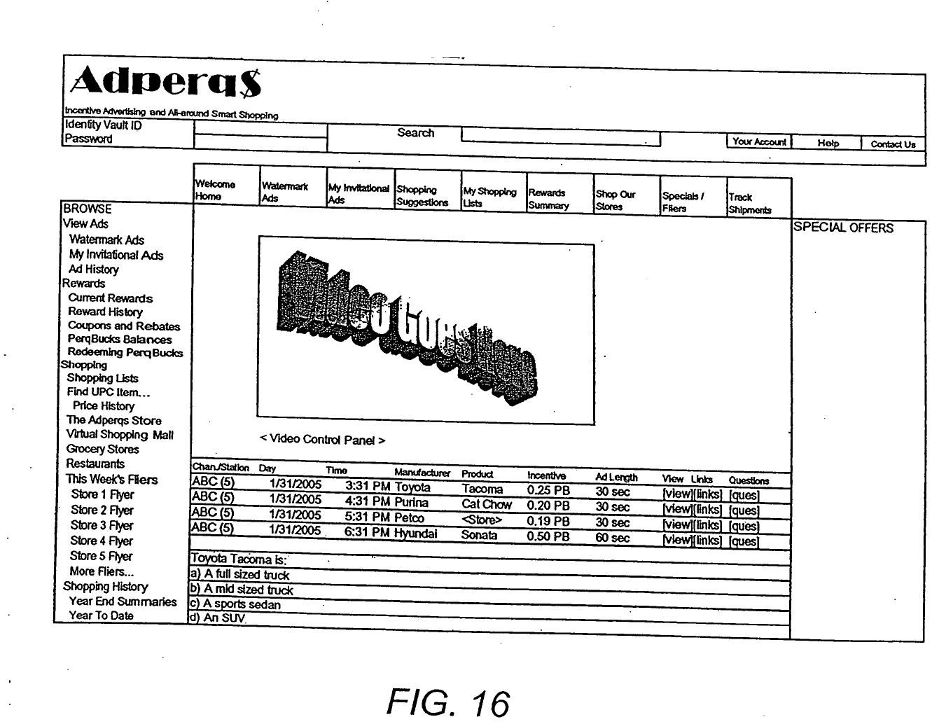

Referring to FIG. 5, the viewer 80 responds to the watermark advertisement via the web by first login onto her account on www.adperqs.com with her identity vault id and password (111). Use of the identity vault id protects her privacy by hiding her real identity. Next the advertisement viewer 80 needs to find the advertisement that she has just seen (112). She can do this in several ways. The first is to search by manufacturer and brand, and if there are multiple commercials for this combination, by an optional commercial id number (113). The second way to search is to search by the date and time the commercial aired, and the channel or station that the commercial aired on (115). Yet another way to search (if the advertisement was a print advertisement) is by the periodical, the date of publication and the page number of the advertisement (114). The advertisement viewer types in the search criteria or selects them from a list and then is presented with all watermark advertisements that match the search criteria (116). The advertisements are listed with the duration of the advertisement and the incentive offered, shown in FIG. 16. The viewer can sort the listing by clicking on the column descriptions and can decide which advertisements she wants to respond to. For each advertisement, the viewer can choose to skip answering questions and go directly to a link of information (117), shown in FIG. 8, i.e., where can she buy the product locally? does she want to buy the product now online? what are the special promotions offered for this product? are there soft coupons which she can add to her PerqCard? (140). Alternately, the viewer can answer questions to claim her incentive PerqBucks (119).

Referring to FIG. 9 the process flow 142 for a viewer answering questions about an advertisement includes the following. Until there are no more questions for an advertisement, ask the viewer a multiple choice question (143). The viewer indicates her response to the question either by speaking or by clicking her answer (144). If she is correct, her PerqBucks total is updated and the next question is asked (145). If she is incorrect, a hint, which is usually a playback of a part of the commercial is presented (146). The question is added to the back of the list of questions and the next question is asked.

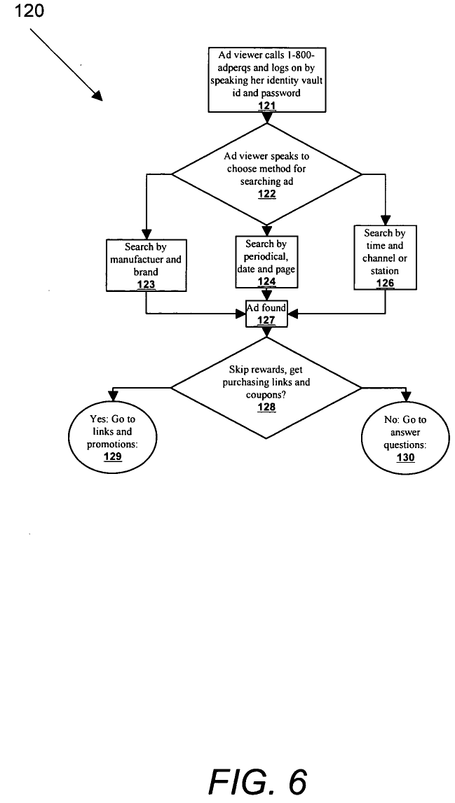

Referring to FIG. 6, the process 120 where the viewer responds via the phone includes first dialing 1-800-adperqs and login onto her account with her identity vault id and password (121). Use of the identity vault id protects her privacy by hiding her real identity. Next the advertisement viewer needs to find the advertisement that she has just seen (122). She can do this in several ways. The first is to search by manufacturer and brand, and if there are multiple commercials for this combination, by an optional commercial id number (123). The second way to search is to search by the date and time the commercial aired, and the channel or station that the commercial aired on (126). Yet another way to search (if the advertisement was a print advertisement) is by the periodical, the date of publication and the page number of the advertisement (124). The advertisement viewer speaks the search criteria and then is presented with all watermark advertisements that match the search criteria. The advertisements are listed with the duration of the advertisement and the incentive offered (127). The viewer can sort the listing by saying the column description name and can decide which advertisements she wants to respond to. For each advertisement, the viewer can choose to skip answering questions and go directly to a link of information (128), shown in FIG. 8: where can she buy the product locally? does she want to buy the product now online? what are the special promotions offered for this product? are there soft coupons which she can add to her PerqCard? (129). Alternately, the viewer can answer questions to claim her incentive PerqBucks (131). The process flow 142 for a viewer answering questions is as described above and shown in FIG. 9.

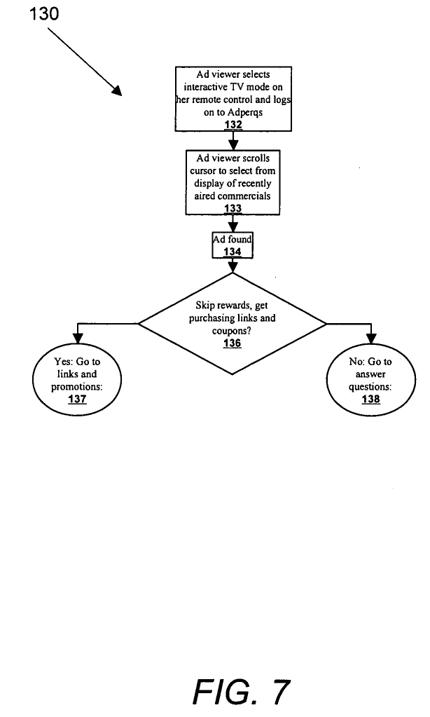

Referring to FIG. 7, the process 130 where the viewer responds via interactive TV includes first turning on the T, connecting to adperqs and login onto her account with her identity vault id and password (132). Use of the identity vault id protects her privacy by hiding her real identity. Next the advertisement viewer needs to find the advertisement that she has just seen (133). The most recently viewed advertisements are listed on her interactive TV screen. She scrolls the cursor to the one she wants to respond to and hits enter (134). For each advertisement, the viewer can choose to skip answering questions and go directly to a link of information (136), shown in FIG. 8: where can she buy the product locally? does she want to buy the product now online? what are the special promotions offered for this product? are there soft coupons which she can add to her PerqCard? (137). Alternately, the viewer can answer questions to claim her incentive PerqBucks (138). The process flow 142 for a viewer answering questions is as described above and shown in FIG. 9.

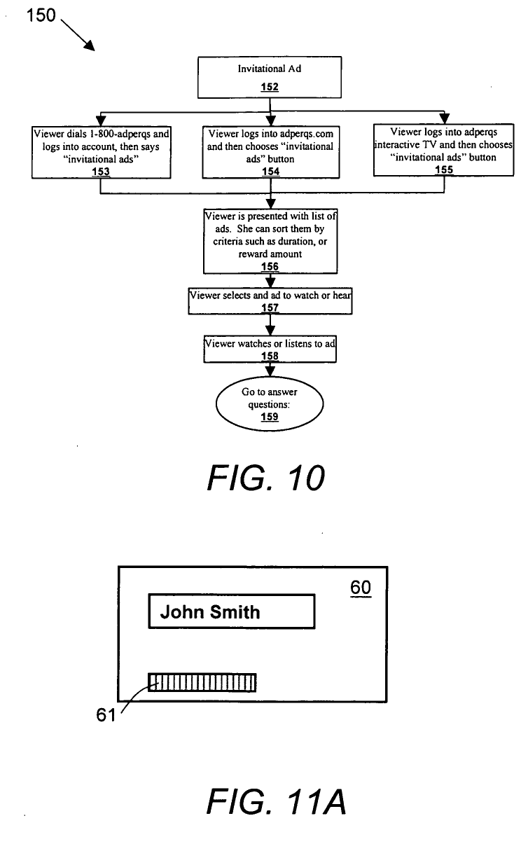

Referring to FIG. 10, the process 150 for responding to an invitational advertisement includes the following. Based on criteria calculated from a viewer's adperqs profile, manufacturers, merchants and advertisers will choose highly targeted viewers to view their commercials (152). These selected viewers are added to the list in the adperqs central database, and the amount of their incentive can be varied based on such variables as their yearly spending budget, or their interest level in a category of products. From time to time, viewers will log into adperqs either by phone (153), or on the web (154), or by interactive TV (155) to check what new commercials they have been chosen to see. By whichever medium the viewer chooses, she will indicate that she wants to see invitational advertisements. Then she will be presented with a list of advertisements that she is qualified for (156). She can search and sort the list based on various criteria, including the duration of the advertisement, or the incentive offered. She selects each advertisement (157), watches it (158), and then answers questions to earn rewards (159).

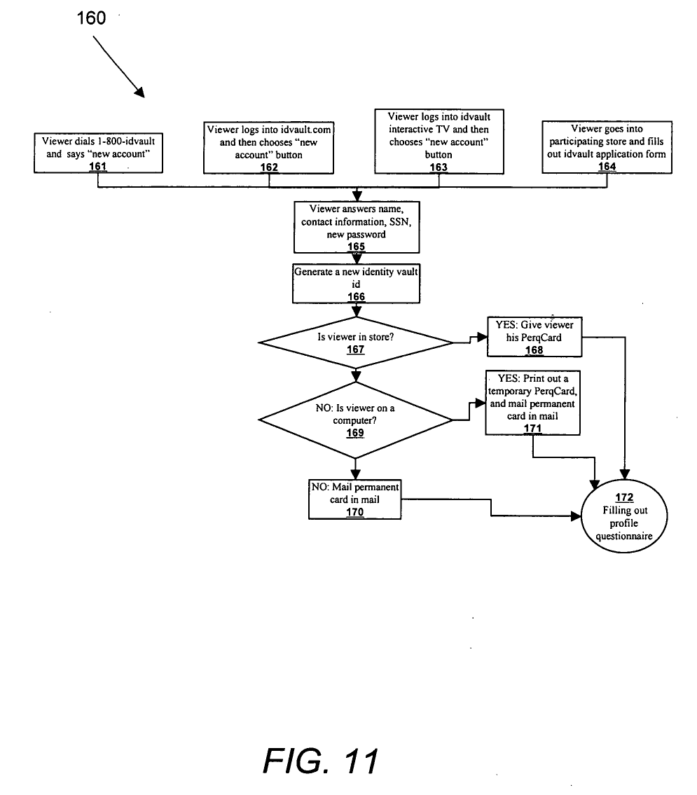

The PerqCard universal incentive card 60, shown in FIG. 11A, is a card that is similar to the incentive store cards used today at individual stores. However, the PerqCard 60 is a universal card which can be used in many different stores, eliminating the need to carry many different cards and creating a more powerful associated central database, because a shopper's total activity is stored and retained. The PerqCard 60 contains a laser-scan able barcode 61 which links to a shoppers Adperqs central database account. The PerqCard 60 protects a user's privacy by separating the user's personally identifiable information from the actual activity that is posted to his account.

Referring to FIG. 11, the process 160 for signing up for a PerqCard includes the following. There are several venues for getting a PerqCard 60. Note that the initial step of getting a PerqCard 60 is done at Identity Vault, a completely separate entity from Adperqs. The consumer can call 1-800-IDVAULT and interact by voice with the automated system (161). She can log onto idvault.com (162). She can connect via interactive TV to IDVault (163). Alternately, she can go to a participating store and fill out an Identity Vault application form (164). The information collected for the application includes name, contact information, social security number, and a user selected password (165). Once this information is collected, the system will generate a unique Identity Vault ID (166). If the consumer is in a store (167), he will be given a permanent PerqCard card which has a barcode of her new Identity Vault ID (168). If the consumer is on a computer (169), she can print out a temporary PerqCard (171), and a permanent PerqCard will be sent to her in the mail (170). Otherwise, the consumer will have to wait until the permanent card is sent in the mail (170).

The PerqCard contains an Identity Vault ID, which links to an Adperqs account which contains a profile of the consumer's interests along with an automatically updated database of purchases that the consumer has made. Since being an active shopper qualifies the shopper for better incentive advertisement offers and better purchasing offers, she does not mind giving her shopping activity information to adperqs. This is especially true because her personally identifiable information is not linked to her adperqs account. Once the consumer has an Identity Vault ID, she can fill out her interests profile and be entered into a sweepstakes as an incentive (172).

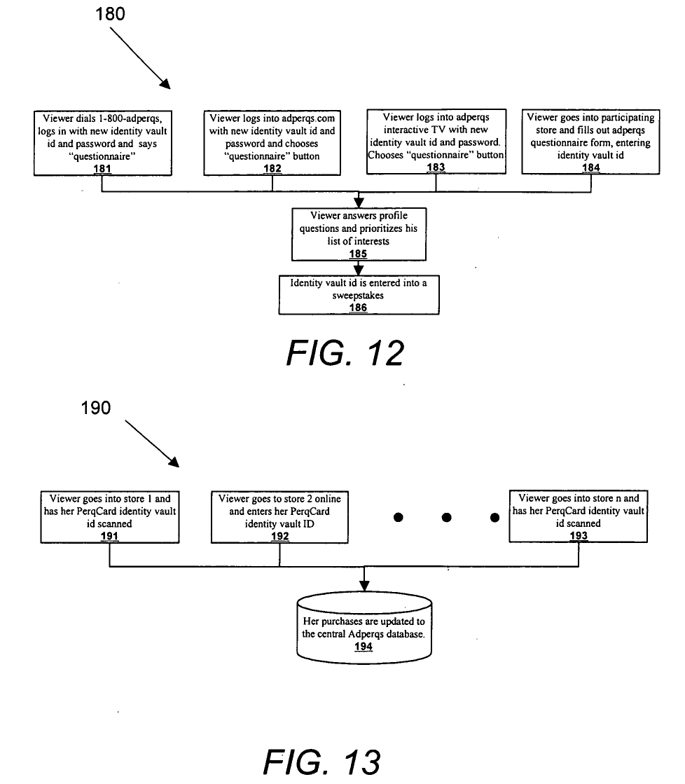

Referring to FIG. 12, the process 180 of filling out the questionnaire includes the following. There are several ways for a consumer to complete the adperqs questionnaire. The consumer can dial 1-800-adperqs, log on with her identity vault id and password (181). The consumer can log onto adperqs.com with her identity vault id and password (182). The consumer can log onto interactive TV with her identity vault id and password (183). The consumer can go into a participating store and fill out an adperqs interest profile (184). The consumer is asked to prioritize her list of interests (185): Does she own a dog, is she in the market to buy a car, does she enjoy gardening? The interests are prioritized so that a consumer cannot abuse the system by specifying an interest in everything. Lesser interest items will beget lesser rewards. Once the questionnaire is complete, the identity vault id is entered into a sweepstakes as an incentive for the consumer to fill out the questionnaire (186).

Referring to FIG. 13, the process 190 for updating the consumer's centralized adperqs profile database includes the following. Whether the consumer goes into a brick and mortar store (191) and has her PerqCard scanned, or whether she enters her Identity Vault ID into an online store (192), her purchases are updated to a centralized adperqs profile database (194). The purchases become available for merchants and manufacturers to offer special promotions. For example, a manufacturer may offer the consumer discounts for reaching certain levels of purchase. The effect is to create a virtual wholesaler, because the incentive can be offered to a consumer by a manufacturer no matter which store or merchant she purchases the product from. The sales information in the centralized database is also made available to the individual consumer so that she can analyze her spending habits and get a full history of where her money goes. Finally, the information in the centralized database is also used to store the amount of PerqBucks that a consumer has, and to update or decrement her account as she earns more rewards or spends them. “Soft” coupons are also stored in the account and are updated or decremented as they are rewarded or redeemed.

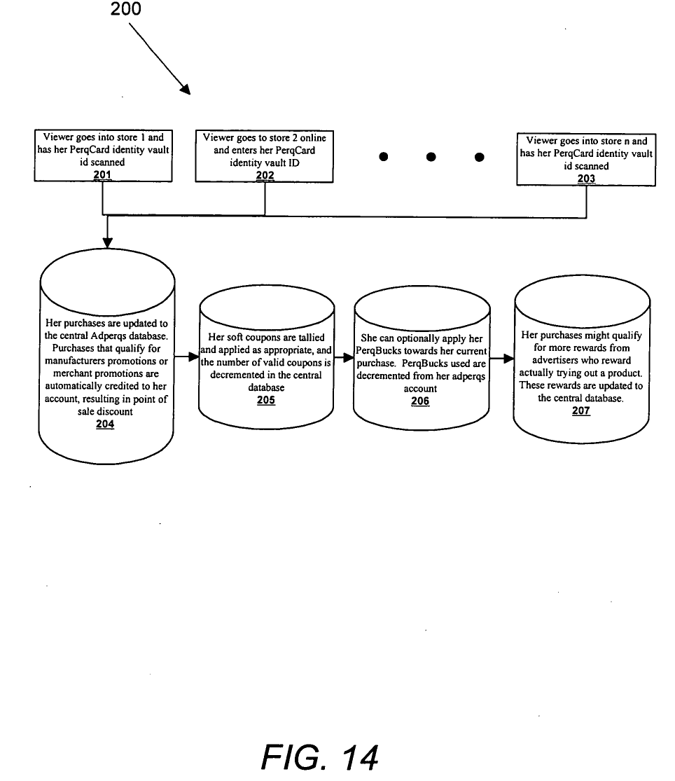

Referring to FIG. 14, the process 200 of redeeming coupons and PerqBucks includes the following. The consumer either goes into a store and has her PerqCard scanned (201) or she goes shopping online and enters her Identity Vault ID and password (202). Her purchases are updated to the central Adperqs database (204). Purchases that qualify for manufacturers promotions or merchant promotions are automatically credited to her account, resulting in point of sale discount (204). Her soft coupons are tallied and applied as appropriate, and the number of valid coupons is decremented in the central database (205). She can optionally apply her PerqBucks towards her current purchase. PerqBucks used are decremented from her adperqs account (206). Her purchases might qualify for more rewards from advertisers who reward the act of actually trying out a product. These rewards are updated to the central database (207).

The Adperqs entity also runs a broadcast or cable TV station which runs advertisements that qualify for incentives on a 24/7 basis. Airtime is relatively cheap when the advertiser does not have to pay for the cost of programming.

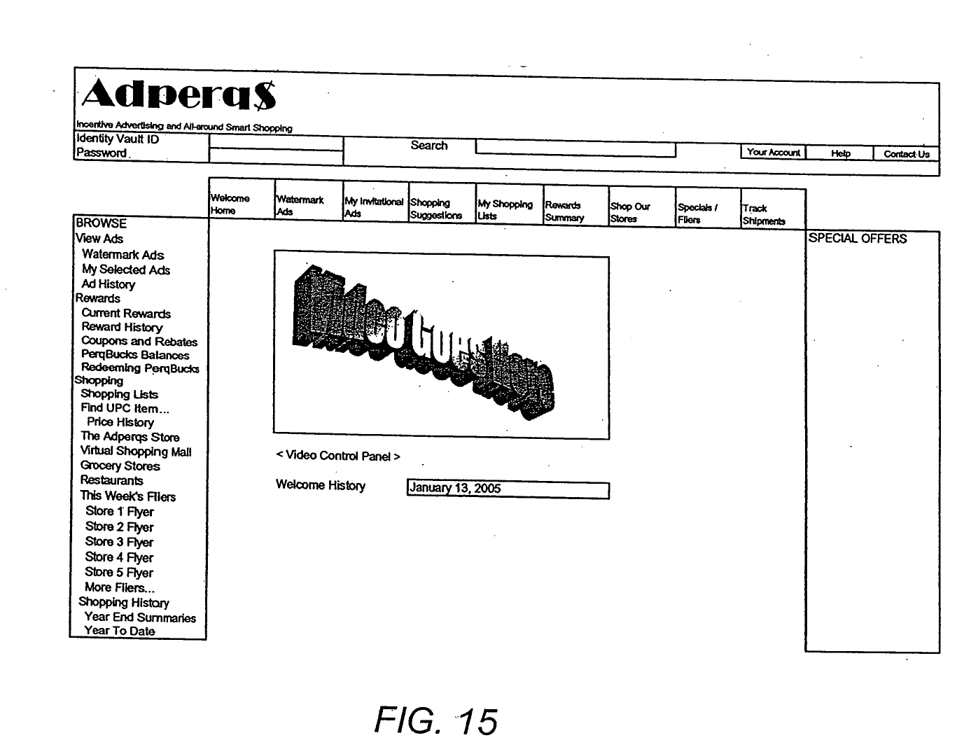

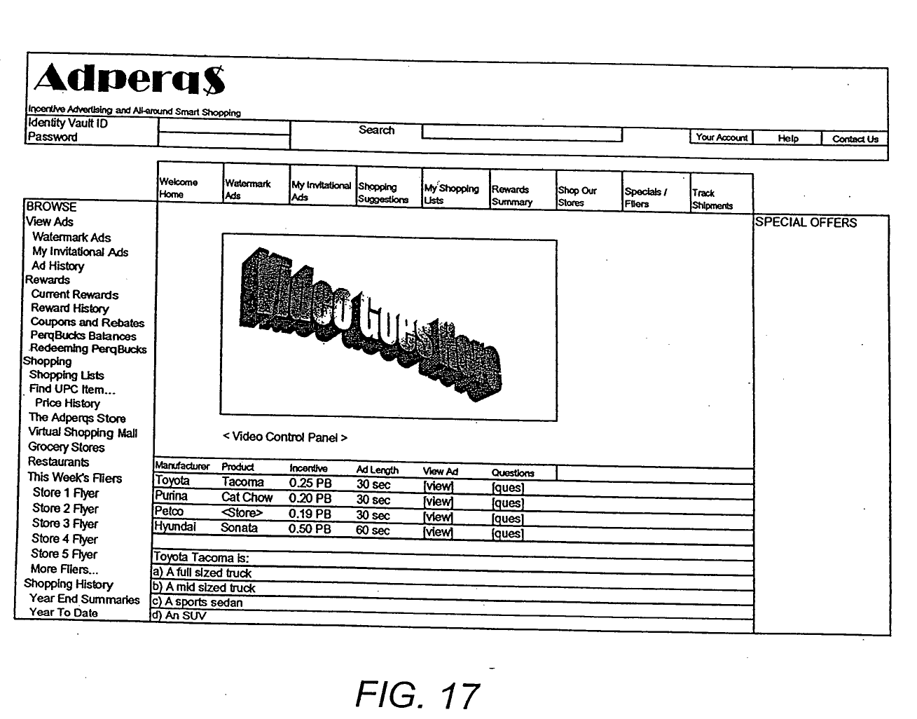

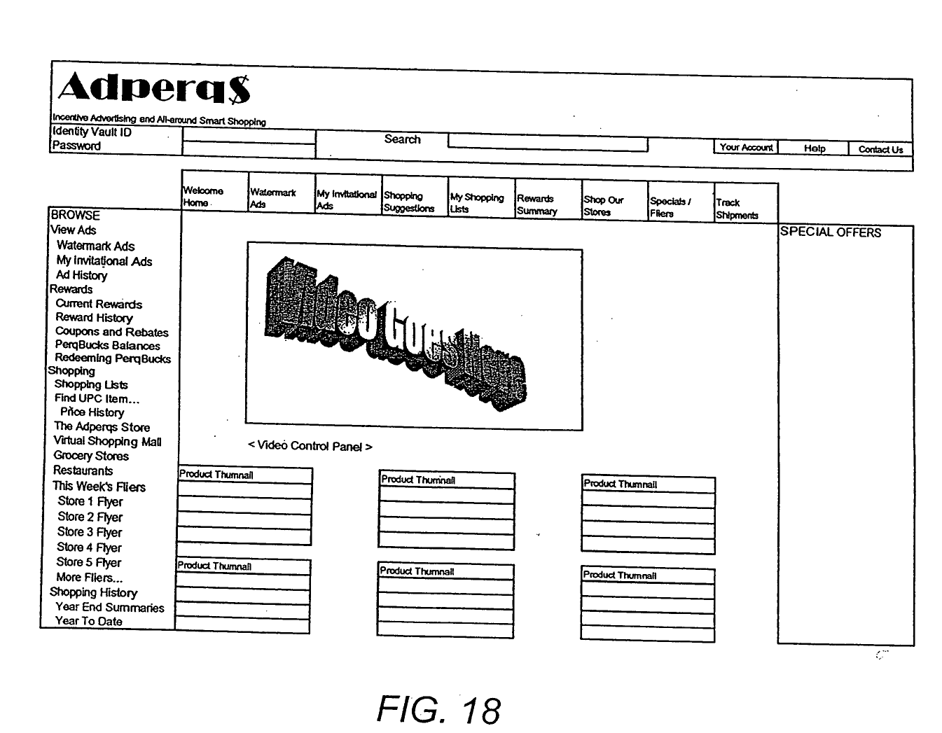

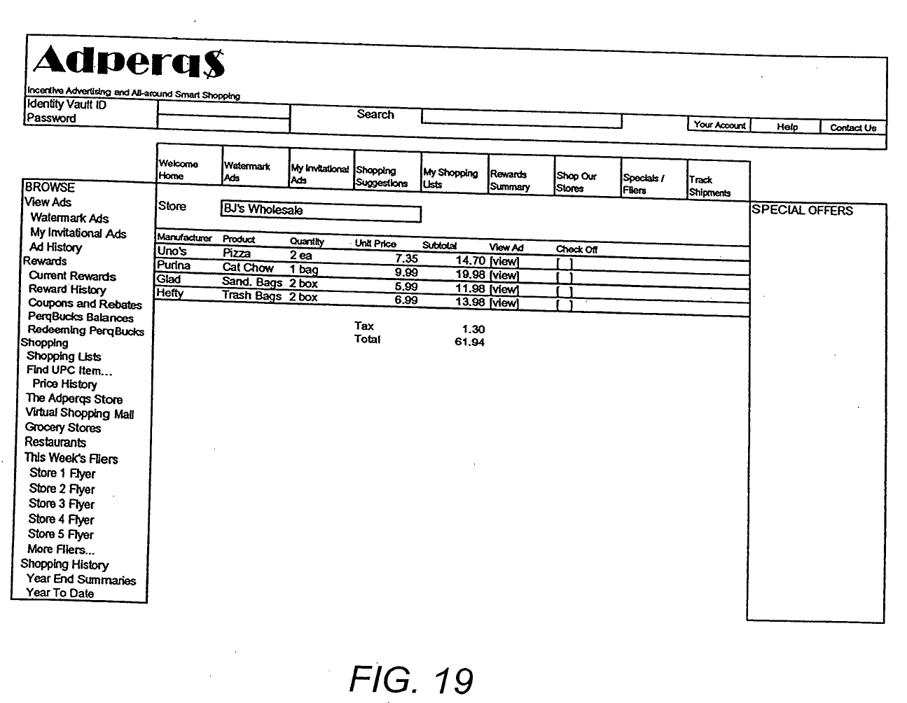

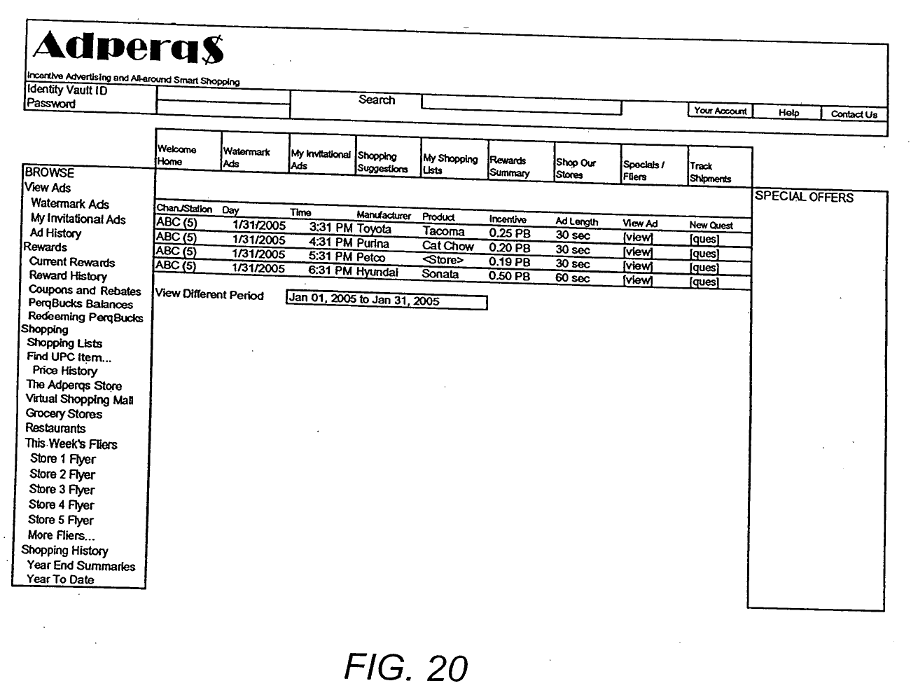

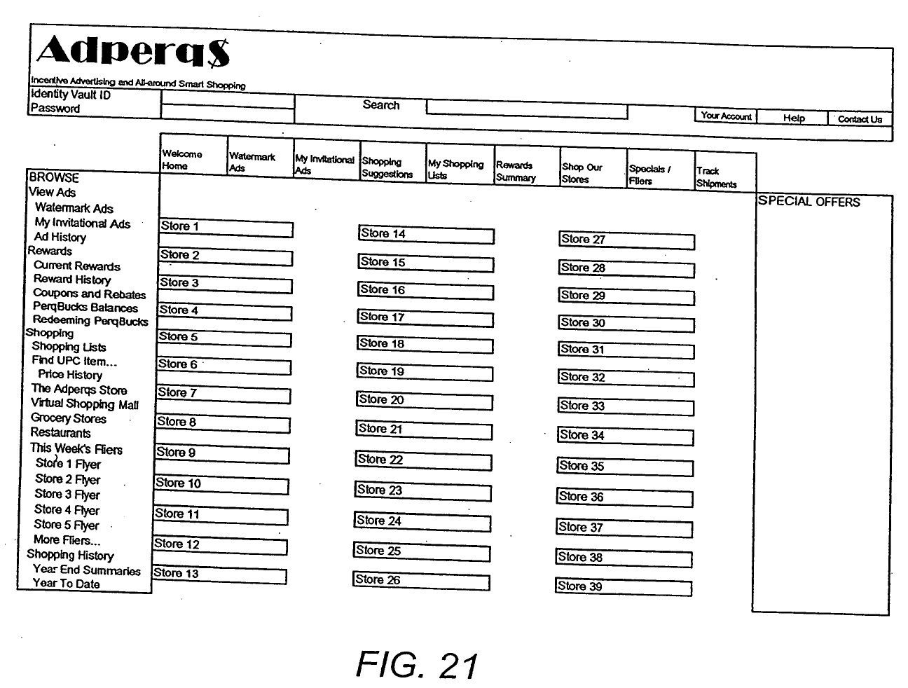

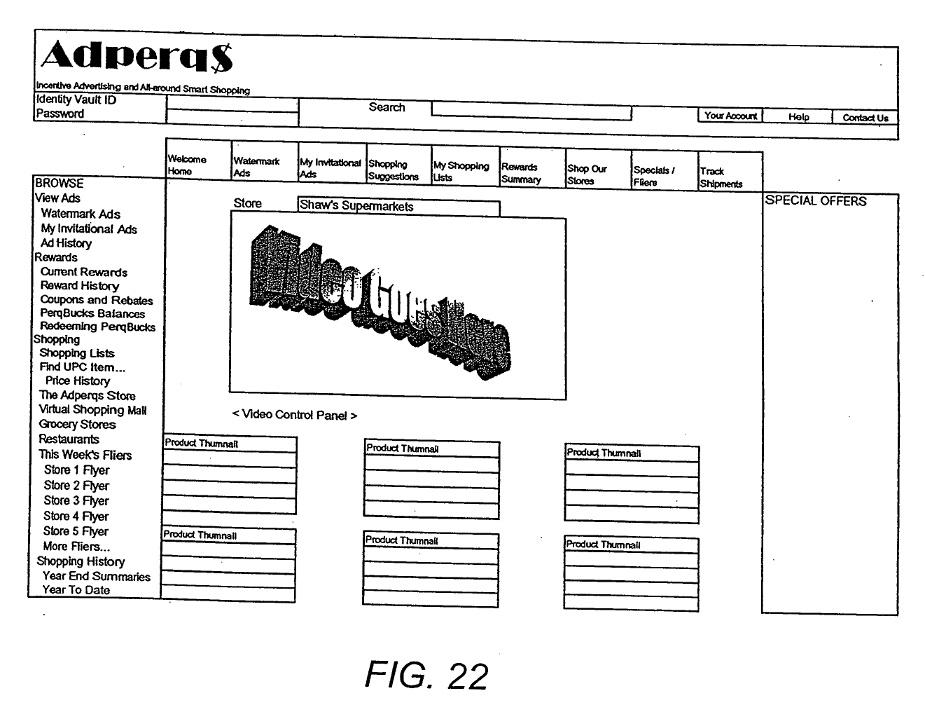

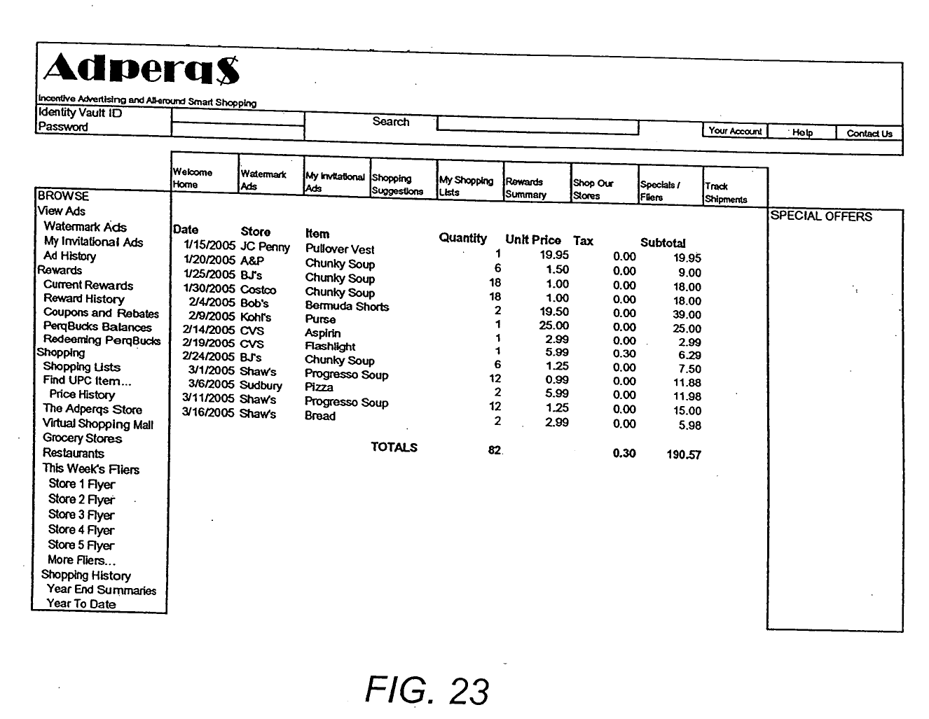

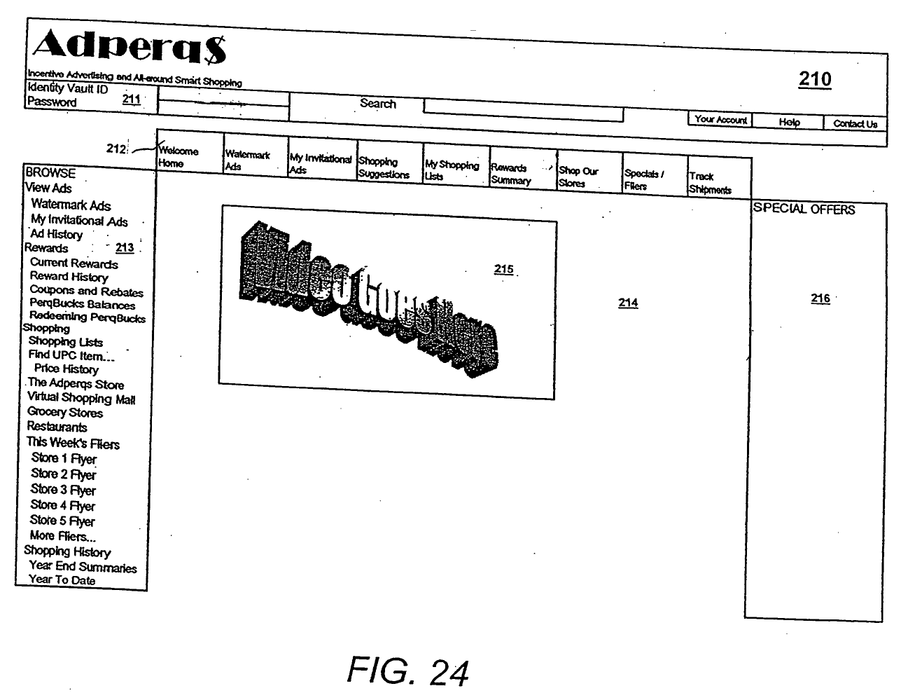

The Adperqs entity runs www.adperqs.com, a website that centralizes the activities of a consumer relating to the present invention's method for motivating a consumer to behave in a certain way. Referring to FIG. 24, the website template 210 includes entry fields for the Identity Vault ID and the password for logging in 211, a navigation bar for activating the various pages of the website 212, tab buttons to access commonly used pages of the website 213, the “client area” of the page where page specific information is displayed 214, a video screen where full motion advertisements are displayed 215, and a side bar that offers the user special deals which are tailored to her profile 216. In the preferred embodiment of adperqs.com, most advertisements and items offered for sale will be full motion commercials or demos. The Adperqs.com welcome screen where the Adperqs entity communicates with the site user is shown in FIG. 15. FIG. 16 shows the watermark advertisements screen where the user goes to find advertisements that she has seen in the real world so that she can answer questions about them to earn incentives. FIG. 17 shows the invitational advertisements screen where the user goes to find the advertisements that she has been selected to see based on her consumer profile. FIG. 18 shows a screen where suggestions are made to the consumer for products that she might be interested in. There are product thumbnails towards the bottom of the screen. Selecting any of these activates the video in the video screen above. FIG. 19 shows a screen where the consumer can make shopping lists for one or multiple stores. The prices at each store are available online and the shopper is able to easily add the product to one or another store. FIG. 20 shows a screen where the consumer can view the rewards and incentives that she has earned and redeemed over time. FIG. 21 shows a screen of links to stores in the Adperqs virtual mall. FIG. 22 shows a screen which is one of several periodic fliers for local or national stores. FIG. 23 shows a screen which lists, categorizes and sorts a consumer's purchases so that she can analyze her spending and become a more educated consumer.

Other embodiments are within the scope of the following claims. For example, the advertisement viewer may also interact with Adperqs via phones with Evolution-Data Optimized (EV-DO) which can stream video. This type of interaction is similar to Interactive TV, because the advertisement viewers can press buttons on the phone in response to advertisements. Advertisement viewers can get PerqBucks for trying out a product, and that those PerqBucks are good for any purchase where PerqBucks are accepted, and not just for buying the advertised product. In one example the PerqCard card is a Visa gift card. If a merchant does not participate in the Adperqs program the user can input his purchases into the central marketing database to increase his/her rewards per advertisement viewed. This is done by scanning the purchase receipts via software/hardware such as the NeatReceipt product. Another way to encourage users to pay attention to advertisements is that there is an online quiz game where users can win more money than they get for answering simple questions. This is different from the sweepstakes, which does not require correct answers. The quiz game asks questions that are more complex/difficult than the advertisement view questions. For example: What color is the Toyosan Vanacar in the commercial. The player would have to do this from memory and there would be no prompts. One of the things that make Adperqs fun rather than a nuisance is that periodically, the user will get an email notifying him/her of available advertisements to view. This is a hypertext message which will bring the user directly to the advertisement/quiz in the website without having to log in. Login is automatic via cookies. Adperqs also awards PerqBucks for referrals to other customers. Referrals are verified by computer online and represent Adperqs' ability to advertise via word of mouth. Adperqs may also include competitive rebates. For obtaining a competitive rebate, Adperqs users log into the website to search for a type of product or service. In response to their search, they get replies from sponsored advertisers who offer PerqBucks for viewing their commercials/demos. Once the Adperqs user actually buys a product or service from that category, regardless of which vendor won, all the vendors from that category award the Adperqs user PerqBucks.

Several embodiments of the present invention have been described. Nevertheless, it will be understood that various modifications may be made without departing from the spirit and scope of the invention. Accordingly, other embodiments are within the scope of the following claims.

What is claimed is:

1. A computer implemented method for improving consumers' attention and effectiveness of advertisement comprising:
viewing and/or listening to an advertisement, wherein said advertisement comprises a mark identifying said advertisement and pointing to a network based system, wherein said network based system comprises a database listing of said advertisement;
connecting to said network based system and selecting said advertisement;
answering one or more questions about content of said advertisement within said network based system; and
receiving reward points for providing correct answers to said one or more questions.

2. The method of claim 1 wherein said network based system is selected from a group consisting of a website, a telephone station and an interactive television station and wherein said network based system is accessed via a network connection selected from a group consisting of the Internet, telecommunications network, local area network (LAN), wide area network (WAN), wireless network, and wired network.

3. The method of claim 1 further comprising providing hints assisting said consumers with said answering of said one or more questions.

4. The method of claim 1 wherein said advertisement comprises an advertisement for a product or a service and said method further comprising providing a link to venues selling said product or service.

5. The method of claim 4 further comprising receiving coupons or other incentives for buying said product or service.

6. The method of claim 5 further comprising receiving rewards for trying said product or service.

7. The method of claim 1 further comprising storing said reward points in a universal incentive card.

8. The method of claim 7 wherein said universal incentive card comprises a unique identification code linking said universal incentive card to a consumer and to a consumer account in said system.

9. The method of claim 1 further comprising redeeming said reward points by purchasing goods or services.

10. The method of claim 1 wherein said network based system further comprises a consumer database comprising consumer accounts, and wherein said consumer accounts comprise information selected from a group consisting of consumer user id, consumer security id, consumer profile, purchases, reward points, incentives, coupons, “soft” coupons, interests, and advertisement viewing/listening records.

11. The method of claim 10 further comprising recording said reward points into said consumer accounts.

12. The method of claim 10 further comprising analyzing said consumer account information, identifying specific consumer group profiles and targeting said specific consumer groups based on their interests and consuming habits.

13. The method of claim 10 wherein said consumers monitor their consuming habits through said network based system.

14. The method of claim 1 further comprising inviting said consumers to view and/or listen to said advertisement.

15. The method of claim 1 further comprising registering a consumer into said network based system, and assigning a user id and a security id to said consumer.

16. The method of claim 15 further comprising collecting information about said consumer and defining a user profile for said consumer.

17. The method of claim 2 wherein said network based system comprises a website and wherein said website comprises a plurality of interlinked web pages stored in a memory and said memory is couple to a computing circuit and to a communications interface for communicating via the Internet.

18. The method of claim 17 wherein said website comprises means to access said database listing of said advertisement, means to select said advertisement based on said mark, means to view said advertisement, means to access consumer accounts, means to monitor consuming habits, links to stores for buying goods and services, and means to keep track of reward points.

19. The method of claim 1 further comprising entering a user into a prize winning drawing.

20. A system for improving consumers' attention and effectiveness of advertisement comprising:
equipment for viewing and/or listening to an advertisement, wherein said advertisement comprises a mark identifying said advertisement and pointing to a network based system, wherein said network based system comprises a database listing of said advertisement;
equipment and applications for connecting to said network based system and selecting said advertisement;
means for answering one or more questions about content of said advertisement within said network based system; and
means for receiving reward points for providing correct answers to said one or more questions.

21. The system of claim 20 wherein said equipment for viewing and/or listening to said advertisement is selected from a group consisting of a television display screen, a computer display screen, a projection display screen, a radio, a phone equipped with or without a screen, a magazine, a written publication, a book and an advertisement flyer.

22. The system of claim 20 wherein said equipment and applications for connecting to said network based system are selected from a group consisting of communications modem for network connections, communications interfaces, and web browsers.

23. The system of claim 20 wherein said network based system is selected from a group consisting of a website, a telephone station and an interactive television station and wherein said network based system is accessed via a network connection selected from a group consisting of the Internet, telecommunications network, local area network (LAN), wide area network (WAN), wireless network, and wired network.

24. The system of claim 20 further comprising means for providing hints assisting said consumers with said answering of said one or more questions.

25. The system of claim 20 wherein said advertisement comprises an advertisement for a product or a service and said system further comprising means for providing a link to venues selling said product or service.

26. The system of claim 25 further comprising means for providing coupons or other incentives for buying said product or service.

27. The system of claim 26 further comprising means for receiving rewards for trying said product or service.

28. The system of claim 27 further comprising means for storing said reward points in a universal incentive card.

29. The system of claim 28 wherein said universal incentive card comprises a unique identification code linking said universal incentive card to a consumer and to a consumer account in said system.

30. The system of claim 20 further comprising means for redeeming said reward points by purchasing goods or services.

31. The system of claim 20 wherein said network based system further comprises a consumer database comprising consumer accounts, wherein said consumer accounts comprise information selected from a group consisting of consumer user id, consumer security id, consumer profile, purchases, reward points, incentives, coupons, “soft” coupons, interests, and advertisement viewing/listening records.

32. The system of claim 31 further comprising means for recording said reward points into said consumer accounts.

33. The system of claim 31 further comprising means for analyzing said consumer account information, identifying specific consumer group profiles and targeting said specific consumer groups based on their interests and consuming habits.

34. The system of claim 31 wherein said consumers monitor their consuming habits through said computer system.

35. The system of claim 20 further comprising means for inviting said consumers to view and/or listen to said advertisement.

36. The system of claim 20 further comprising means for registering a consumer into said network based system, and assigning a user id and a security id to said consumer.

37. The system of claim 36 further comprising means for collecting information about said consumer and defining a user profile for said consumer.

38. The system of claim 20 wherein said network based system comprises a website and wherein said website comprises a plurality of interlinked web pages stored in a memory and said memory is couple to a computing circuit and to a communications interface for communicating via the Internet.

39. The system of claim 38 wherein said website comprises means to access said database listing of said advertisement, means to select said advertisement based on said mark, means to view said advertisement, means to access consumer accounts, means to monitor consuming habits, links to stores for buying goods and services, and means to keep track of reward points.

40. The system of claim 20 further comprising means for entering a user into a prize-winning drawing.
